(19) United States
(12) Patent Application Publication
(10) Pub. No.: US 2024/0403401 A1
(43) Pub. Date: Dec. 5, 2024

(54) PROCESSING EXECUTION APPARATUS, USER TERMINAL, AUTHENTICATION SYSTEM, PROCESSING EXECUTION METHOD, AUTHENTICATION METHOD, AND COMPUTER READABLE MEDIUM

(71) Applicant: NEC Corporation, Minato-ku, Tokyo (JP)

(72) Inventor: Hajime SUZUKI, Tokyo (JP)

(73) Assignee: NEC Corporation, Minato-ku, Tokyo (JP)

(21) Appl. No.: 18/700,367

(22) PCT Filed: Nov. 15, 2021
(86) PCT No.: PCT/JP2021/041853

§ 371 Date: Apr. 11, 2024

(51) Int. Cl. G06F 21/32

(52) U.S. Cl. CPC G06F 21/32

(57) ABSTRACT

A processing execution apparatus includes: an acquisition unit that acquires certification information indicating that a first biometric authentication has succeeded from a user terminal possessed by a user after the user moves into a first range of a location where the processing execution apparatus is installed, the first biometric authentication being performed based on a first captured image in which the user is imaged by the user terminal outside the first range; an authentication control unit that initiates a control of a second biometric authentication for the user when the certification information is acquired; and an execution unit that executes predetermined processing when the second biometric authentication has succeeded.

### TECHNICAL FIELD

The present invention relates to a processing execution apparatus, a user terminal, an authentication system, a processing execution method, an authentication method, and a program, and more particularly, to a processing execution apparatus, a user terminal, an authentication system, a processing execution method, an authentication method, and a program capable of executing processing using biometric authentications.

### BACKGROUND ART

In recent years, payment processing using a face authentication has been widely used. Patent Literature 1 discloses a technology related to a sales management system that performs a face authentication at the time of payment. The system according to Patent Literature 1 includes a store-visit detecting store terminal installed at the entrance of the store, a sales management server, a purchase supporting store terminal that performs a payment, and a storage medium storing a proximity ID. The store-visit detecting store terminal acquires a proximity ID from the storage medium possessed by a store visitor (user), and registers the proximity ID in the sales management server. When the user purchases a product, the purchase supporting store terminal and the sales management server perform payment processing after performing a face authentication of the user using a user ID associated with the proximity ID.

In addition, although the accuracy of biometric authentication such as face authentication is improved, there remains a risk of false authentication. Therefore, two-factor authentication using different authentication methods may be used to perform predetermined processing.

### CITATION LIST

### Patent Literature

Patent Literature 1: Japanese Unexamined Patent Application Publication No. 2016-157294

### SUMMARY OF INVENTION

### Technical Problem

However, in order to perform the two-factor authentication immediately before the payment processing to reduce the likelihood of false authentication, it is necessary to install a device for acquiring certification information using a plurality of authentication methods in the vicinity of the payment terminal, which is a problem in that installation costs are incurred. In addition, in a case according to Patent Literature 1, it is necessary to install a terminal for detecting a proximity ID at an entrance of a store, which also incurs installation costs.

In view of the above-described problems, an object of the present disclosure is to provide a processing execution apparatus, a user terminal, an authentication system, a processing execution method, an authentication method, and a program for reducing the likelihood of false authentication while suppressing costs in processing according to success of biometric authentication.

### Solution to Problem

According to a first aspect of the present disclosure, a processing execution apparatus includes:

an acquisition means for acquiring certification information indicating that a first biometric authentication has succeeded from a user terminal possessed by a user after the user moves into a first range of a location where the processing execution apparatus is installed, the first biometric authentication being performed based on a first captured image in which the user is imaged by the user terminal outside the first range;
an authentication control means for initiating a control of a second biometric authentication for the user when the certification information is acquired; and
an execution means for executing predetermined processing when the second biometric authentication has succeeded.

According to a second aspect of the present disclosure, a user terminal includes:
an acquisition means for acquiring a first captured image obtained by imaging a user outside a first range of a location where a processing execution apparatus is installed;
an authentication control means for controlling a first biometric authentication by transmitting biometric information based on the first captured image to an authentication server;
a storage means for storing certification information acquired from the authentication server when the first biometric authentication has succeeded, the certification information indicating the success; and
an output means for outputting the certification information to cause the processing execution apparatus to perform a control of a second biometric authentication for the user and perform predetermined processing after the user moves into the first range.

According to a third aspect of the present disclosure, an authentication system includes:
a user terminal possessed by a user;
an authentication server configured to perform a biometric authentication; and
a processing execution apparatus installed at a first location and configured to execute predetermined processing, in which
the user terminal acquires a first captured image obtained by imaging the user outside a first range of the first location, and performs a control of a first biometric authentication by transmitting biometric information based on the first captured image to the authentication server,
the authentication server transmits certification information to the user terminal when the first biometric authentication has succeeded, the certification information indicating the success,
the user terminal stores the certification information acquired from the authentication server, and outputs the certification information after the user moves into the first range, and
the processing execution apparatus initiates a control of a second biometric authentication for the user when the certification information is acquired from the user terminal, and executes the predetermined processing when the second biometric authentication has succeeded.

According to a fourth aspect of the present disclosure, a processing execution method includes:
by a computer installed at a first location,
acquiring certification information indicating that a first biometric authentication has succeeded from a user terminal possessed by a user after the user moves into a first range of the first location, the first biometric authentication being performed based on a first captured image in which the user is imaged by the user terminal outside the first range;
initiating a control of a second biometric authentication for the user when the certification information is acquired; and
executing predetermined processing when the second biometric authentication has succeeded.

According to a fifth aspect of the present disclosure, a non-transitory computer readable medium stores a program for causing a computer installed at a first location to execute:
acquisition processing of acquiring certification information indicating that a first biometric authentication has succeeded from a user terminal possessed by a user after the user moves into a first range of the first location, the first biometric authentication being performed based on a first captured image in which the user is imaged by the user terminal outside the first range;
authentication control processing of initiating a control of a second biometric authentication for the user when the certification information is acquired; and
execution processing of executing predetermined processing when the second biometric authentication has succeeded.

According to a sixth aspect of the present disclosure, an authentication method includes:
by a computer,
acquiring a first captured image obtained by imaging a user outside a first range of a location where a processing execution apparatus is installed;
controlling a first biometric authentication by transmitting biometric information based on the first captured image to an authentication server;
storing certification information acquired from the authentication server when the first biometric authentication has succeeded, the certification information indicating the success; and
outputting the certification information to cause the processing execution apparatus to perform a control of a second biometric authentication for the user and perform predetermined processing after the user moves into the first range.

According to a seventh aspect of the present disclosure, a non-transitory computer readable medium stores a program for causing a computer to execute:
acquisition processing of acquiring a first captured image obtained by imaging a user outside a first range of a location where a processing execution apparatus is installed;
authentication control processing of controlling a first biometric authentication by transmitting biometric information based on the first captured image to an authentication server;
storage processing of storing certification information acquired from the authentication server in a storage device when the first biometric authentication has succeeded, the certification information indicating the success; and output processing of outputting the certification information to cause the processing execution apparatus to perform a control of a second biometric authentication for the user and perform predetermined processing after the user moves into the first range.

### Advantageous Effects of Invention

According to the present disclosure, it is possible to provide a processing execution apparatus, a user terminal, an authentication system, a processing execution method, an authentication method, and a program for reducing the likelihood of false authentication while suppressing costs in processing according to success of biometric authentication.

### BRIEF DESCRIPTION OF DRAWINGS

FIG. 1 is a block diagram illustrating a configuration of a processing execution apparatus according to a first example embodiment.

FIG. 2 is a flowchart illustrating a flow of a processing execution method according to the first example embodiment.

FIG. 3 is a block diagram illustrating a configuration of a user terminal according to a second example embodiment.

FIG. 4 is a flowchart illustrating a flow of an authentication method according to the second example embodiment.

FIG. 5 is a block diagram illustrating an overall configuration of an authentication system according to a third example embodiment.

FIG. 6 is a block diagram illustrating a configuration of a store management apparatus according to the third example embodiment.

FIG. 7 is a block diagram illustrating a configuration of an authentication apparatus according to the third example embodiment.

FIG. 8 is a flowchart illustrating a flow of face information registration processing performed by the authentication apparatus according to the third example embodiment.

FIG. 9 is a block diagram illustrating a configuration of a user terminal according to the third example embodiment.

FIG. 10 is a diagram illustrating an example in which certification information is displayed according to the third example embodiment.

FIG. 11 is a block diagram illustrating a configuration of a payment terminal according to the third example embodiment.

FIG. 12 is a sequence diagram illustrating a flow of pre-authentication processing according to the third example embodiment.

FIG. 13 is a flowchart illustrating a flow of face authentication processing performed by the authentication apparatus according to the third example embodiment.

FIG. 14 is a sequence diagram illustrating a flow of payment processing according to the third example embodiment.

### EXAMPLE EMBODIMENT

Hereinafter, example embodiments of the present disclosure will be described in detail with reference to the drawings. In the drawings, the same or corresponding elements are denoted by the same reference signs and redundant description will be omitted if necessary for clarity of description.

### First Example Embodiment

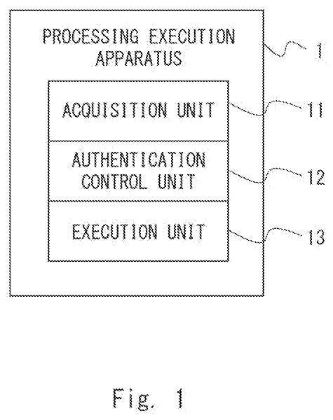

FIG. 1 is a block diagram illustrating a configuration of a processing execution apparatus 1 according to the first example embodiment. The processing execution apparatus 1 is an information processing apparatus installed at a first location (installed location). In addition, a user terminal is an information terminal that can be carried by a user and is capable of wireless communication. It is assumed that the user terminal initially images the user using its imaging function outside a first range of the location where the processing execution apparatus 1 is installed. Then, the user terminal performs a first biometric authentication based on a first captured image in which the user is imaged outside the first range. At this time, it is assumed that the user terminal performs the first biometric authentication on the first captured image using an external authentication server. Here, it is assumed that biometric information of the user is registered in the authentication server in advance. Therefore, the authentication server performs the first biometric authentication by collating biometric information extracted from the first captured image obtained by the user terminal with the registered biometric information. When the first biometric authentication has succeeded, the authentication server transmits, to the user terminal, certification information indicating the success of the first biometric authentication. The user terminal stores the certification information.

Here, the processing execution apparatus 1 includes an acquisition unit 11, an authentication control unit 12, and an execution unit 13. The acquisition unit 11 acquires the certification information from the user terminal after the user moves into the first range of the location where the processing execution apparatus 1 is installed. When the certification information is acquired, the authentication control unit 12 initiates a control of a second biometric authentication on the user. For example, it is assumed that the authentication control unit 12 performs the second biometric authentication on a second captured image in which the user is imaged within the first range using the authentication server. When the second biometric authentication succeeds, the execution unit 13 executes predetermined processing. Here, the predetermined processing is, for example, payment processing or the like, but is not limited thereto.

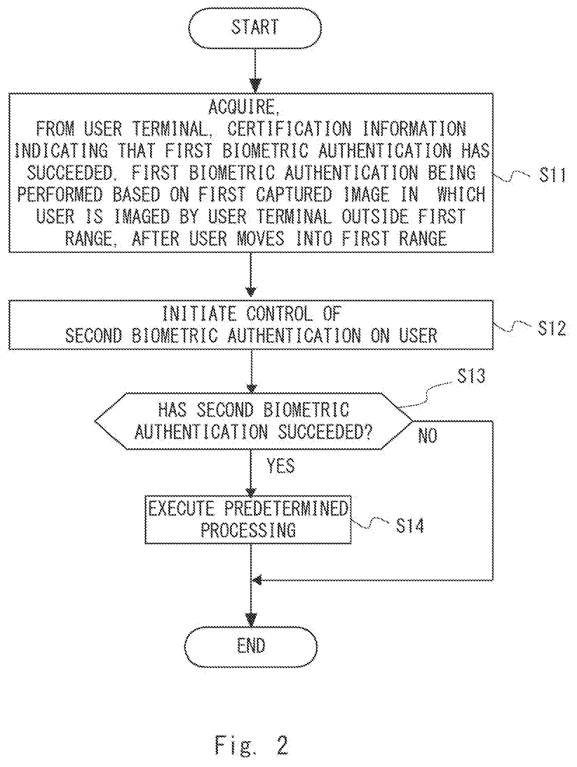

FIG. 2 is a flowchart illustrating a flow of a processing execution method according to the first example embodiment. First, after a user carrying a user terminal moves into a first range of a first location where the processing execution apparatus 1 is installed, the acquisition unit 11 acquires certification information from the user terminal (S11). As described above, the certification information is information indicating that a first biometric authentication has succeeded, the first biometric authentication being performed based on a first captured image in which the user is imaged by the user terminal outside the first range of the first location where the processing execution apparatus 1 is installed.

Next, when the certification information is acquired, the authentication control unit 12 initiates a control of a second biometric authentication on the user (S12). Then, the processing execution apparatus 1 determines whether the second biometric authentication has succeeded (S13). When the second biometric authentication has succeeded, the execution unit 13 executes predetermined processing (S14). On the other hand, when where the second biometric authentication has not succeeded, the execution unit 13 does not execute the predetermined processing.

As described above, the first example embodiment is based on the premise that the first biometric authentication has succeeded on the image of the user captured in advance by the user terminal possessed by the user at a location away from the processing execution apparatus 1 by a predetermined distance or more (outside the first range). At this time, the user terminal holds certification information indicating that the first biometric authentication has succeeded. Then, when the user enters the first range of the processing execution apparatus 1, the processing execution apparatus 1 acquires the certification information from the user terminal possessed by the user. The processing execution apparatus 1 executes predetermined processing on condition that the certification information indicates that the first biometric authentication has succeeded, and the user who currently exists in the first range has succeeded in the second biometric authentication. Here, the first biometric authentication, which is a pre-authentication, is performed using the imaging function of the user terminal possessed by the user, and it is not necessary to separately install an imaging device. Therefore, installation costs can be reduced. In addition, by performing biometric authentications twice to execute the predetermined processing, authentication accuracy can be improved. Therefore, in the processing according to the success of the biometric authentication, it is possible to reduce the likelihood of false authentication while suppressing costs.

Note that the biometric authentication is performed in such a manner that biometric information of a person is extracted from a captured image, the extracted biometric information is collated with biometric information registered in advance, and it is considered that the authentication has succeeded when the matching degree is greater than or equal to a threshold value. Here, as the biometric information, data (feature amount) calculated from a physical feature unique to an individual, such as facial feature information, a fingerprint, a voiceprint, a vein, a retina, an iris of a pupil, or a pattern (pattern) of a palm, may be used.

Note that the processing execution apparatus 1 includes a processor, a memory, and a storage device as components that are not illustrated. In addition, the storage device stores a computer program by which the processing of the processing execution method according to the present example embodiment is implemented. Then, the processor reads the computer program from the storage device into the memory and executes the computer program. As a result, the processor implements the functions of the acquisition unit 11, the authentication control unit 12, and the execution unit 13.

Alternatively, each component of the processing execution apparatus 1 may be implemented by dedicated hardware. In addition, some or all of the components of each apparatus may be implemented by general-purpose or dedicated circuitry, a processor, or a combination thereof. These may be configured by a single chip or may be configured by a plurality of chips connected to each other via a bus. Some or all of the components of each apparatus may be implemented by, for example, a combination of the above-described circuitry and a program. Furthermore, a central processing unit (CPU), a graphics processing unit (GPU), a field-programmable gate array (FPGA), or a quantum processor (quantum computer control chip) can be used as the processor.

Furthermore, in a case where some or all of the components of the processing execution apparatus 1 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which they are connected to each other via a communication network. In addition, the function of the processing execution apparatus 1 may be provided in a software as a service (SaaS) format.

### Second Example Embodiment

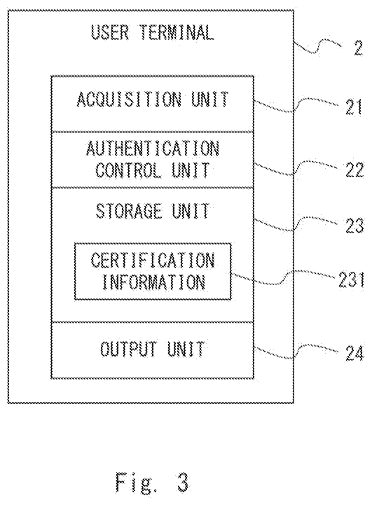

FIG. 3 is a block diagram illustrating a configuration of a user terminal 2 according to the second example embodiment. The user terminal 2 corresponds to the user terminal according to the first example embodiment described above. The user terminal 2 is an information terminal that can be carried by a user and is capable of wireless communication. In addition, a processing execution apparatus is similar to that in the first example embodiment described above. The user terminal 2 includes an acquisition unit 21, an authentication control unit 22, a storage unit 23, and an output unit 24.

The acquisition unit 21 acquires a first captured image obtained by imaging a user outside the first range of the location where the processing execution apparatus is installed. The authentication control unit 22 performs a control of a first biometric authentication by transmitting biometric information based on the first captured image to the authentication server. The storage unit 23 stores certification information 231 indicating that the first biometric authentication succeeded, the certification information 231 being acquired from the authentication server when the first biometric authentication has succeeded. The storage unit 23 may be a storage device itself built in the user terminal 2 or may perform processing of storing the certification information in the storage device. The output unit 24 outputs the certification information 231 to cause the processing execution apparatus to control a second biometric authentication on the user and perform predetermined processing after the user moves into the first range.

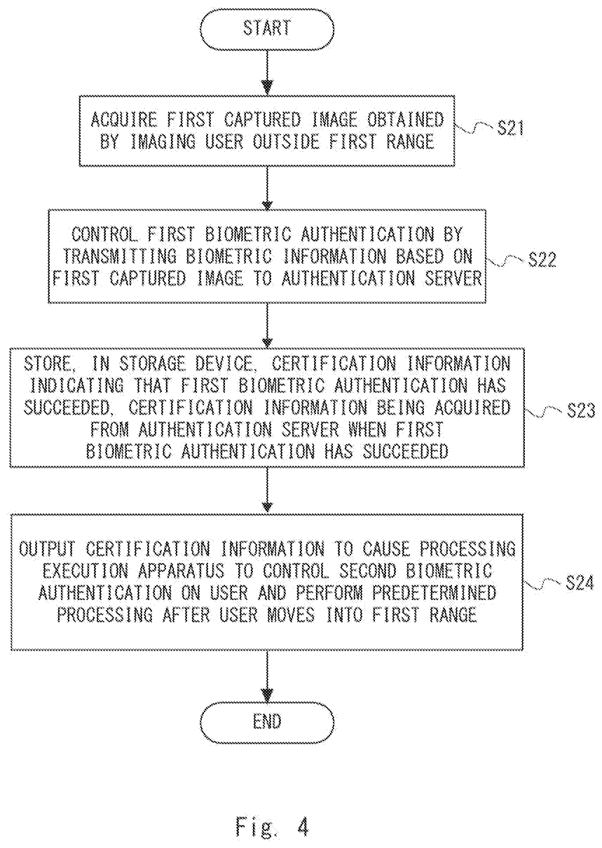

FIG. 4 is a flowchart illustrating a flow of an authentication method according to the second example embodiment. First, the acquisition unit 21 acquires a first captured image obtained by imaging a user outside the first range of the location where the processing execution apparatus is installed (S21). Next, the authentication control unit 22 performs a control of a first biometric authentication by transmitting biometric information based on the first captured image to the authentication server (S22).

Then, the storage unit 23 stores, in the storage device, certification information indicating success, the certification information being acquired from the authentication server when the first biometric authentication has succeeded (S23). Thereafter, after the user moves into the first range of the location where the processing execution apparatus is installed, the certification information is output to cause the processing execution apparatus to control a second biometric authentication on the user and perform predetermined processing (S24).

As described above, in the second example embodiment as well, similarly to the first example embodiment described above, in the processing according to the success of the biometric authentication, it is possible to reduce the likelihood of false authentication while suppressing costs.

Note that the user terminal 2 includes a processor, a memory, and a storage device as components that are not illustrated. In addition, the storage device stores a computer program by which the processing of the authentication method according to the present example embodiment is implemented. Then, the processor reads the computer program from the storage device into the memory and executes the computer program. As a result, the processor implements the functions of the acquisition unit 21, the authentication control unit 22, and the output unit 24.

Alternatively, each component of the user terminal 2 may be implemented by dedicated hardware. In addition, some or all of the components of each apparatus may be implemented by general-purpose or dedicated circuitry, a processor, or a combination thereof. These may be configured by a single chip or may be configured by a plurality of chips connected to each other via a bus. Some or all of the components of each apparatus may be implemented by, for example, a combination of the above-described circuitry and a program. Furthermore, a central processing unit (CPU), a graphics processing unit (GPU), a field-programmable gate array (FPGA), or a quantum processor (quantum computer control chip) can be used as the processor.

### Third Example Embodiment

The third example embodiment is a specific example of the first and second example embodiments described above. In the third example embodiment, an example in which the predetermined processing according to the biometric authentication performed by the processing execution apparatus is payment processing according to a face authentication in a store will be described. Note that the predetermined processing according to the biometric authentication is not limited thereto.

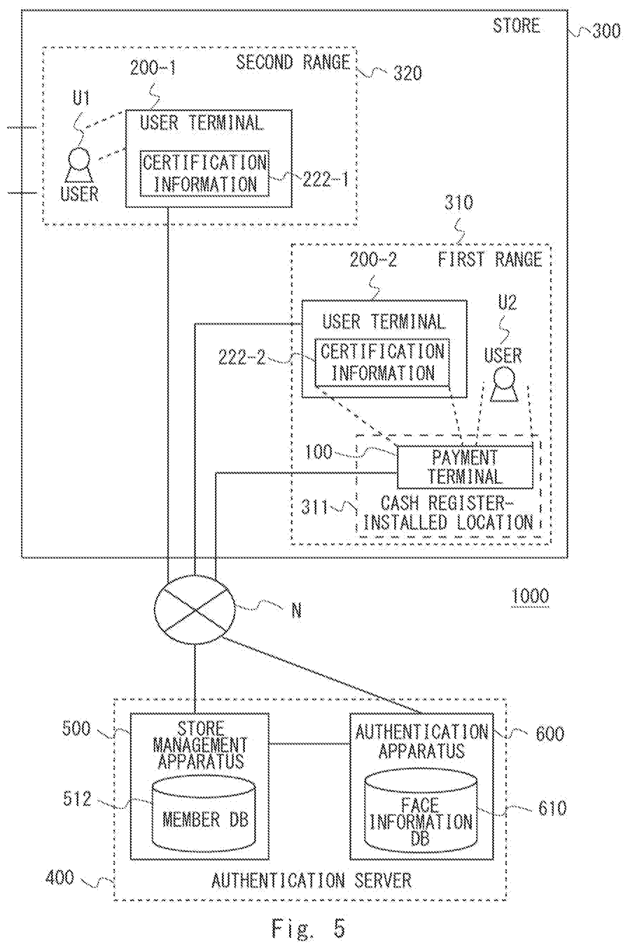

FIG. 5 is a block diagram illustrating an overall configuration of an authentication system 1000 according to the third example embodiment. The authentication system 1000 is an information system that performs payment processing when a person (user) who has visited a store 300 has succeeded in face authentications both at a place away from a cash register-installed location 311 by a predetermined distance (in a second range 320) and in the vicinity of the cash register-installed location 311 (in a first range 310). The face authentication (first biometric authentication) in the second range 320 is performed using an imaging function of a user terminal 200-1 possessed by a user U1. On the other hand, the face authentication (second biometric authentication) in the first range 310 is performed using an imaging function of a payment terminal 100 on condition that the first biometric authentication has succeeded. The payment terminal 100 performs payment processing when the second biometric authentication has succeeded and the user specified by the first biometric authentication match the user specified by the second biometric authentication. Therefore, the user can make a payment in a contactless manner without having to enter a personal identification number or the like. In addition, authentication accuracy can be improved by two-stage authentications.

The authentication system 1000 includes user terminals 200-1 and 200-2, a payment terminal 100, a store management apparatus 500, and an authentication apparatus 600. The store management apparatus 500 and the authentication apparatus 600 may be collectively referred to as an authentication server 400. The user terminals 200-1 and 200-2, the payment terminal 100, the store management apparatus 500, and the authentication apparatus 600 are communicably connected to each other via a network N. Here, the network N is a wired or wireless communication line or communication network, and is, for example, an in-store local area network (LAN), the Internet, a wireless communication line network, a mobile phone line network, or the like. The network N may be of any type of communication protocol.

It is assumed that the users U1 and U2 have registered their face images or facial feature information in advance in a face information database (DB) 610 of the authentication apparatus 600. In addition, it is assumed that the users U1 and U2 have registered their payment information (credit card information, withdrawal bank account information, or the like) in a member DB 512 in advance.

The store management apparatus 500 is an information processing apparatus for performing various kinds of management for the store 300. The store management apparatus 500 may be redundant in a plurality of servers, and each functional block of the store management apparatus 500 may be implemented by a plurality of computers.

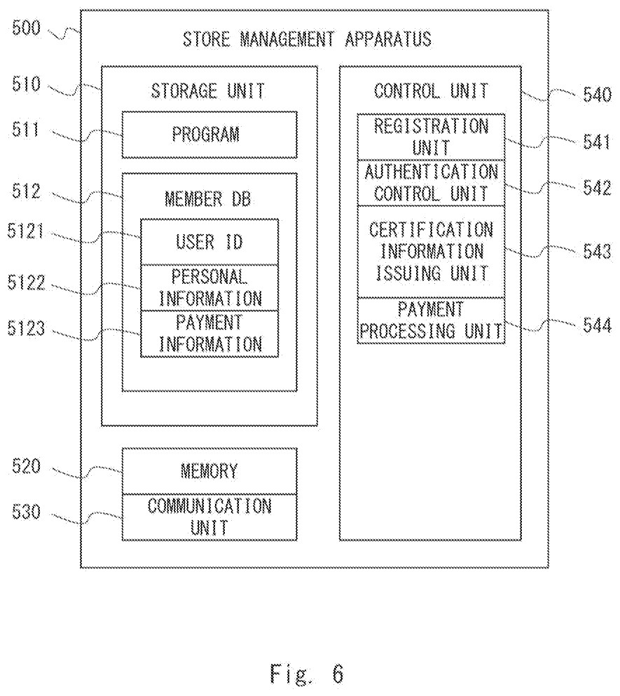

FIG. 6 is a block diagram illustrating a configuration of the store management apparatus 500 according to the third example embodiment. The store management apparatus 500 includes a storage unit 510, a memory 520, a communication unit 530, and a control unit 540. The storage unit 510 is an example of a storage device such as a hard disk or a flash memory. The storage unit 510 stores a program 511 and a member DB 512. The program 511 is a computer program by which some of processing of registration of face information and member information, pre-authentication processing, payment processing, and the like according to the third example embodiment are implemented.

The member DB 512 is a database for managing information about persons registered as members among people who have visited the store 300. In the member DB 512, a user ID 5121, personal information 5122, and payment information 5123 are managed in association with each other. The user ID 5121 is identification information of a user who is a member of the store 300. The user ID 5121 is information corresponding to a user ID 611 of face information DB 610 to be described below. The personal information 5122 is information including the user's name, nickname, address, telephone number, notification destination, and the like. The notification destination is identification information (terminal ID) of a user terminal possessed by the user, a login ID of the user, an e-mail address of the user, an account of a social networking service (SNS) of the user, or the like. The payment information 5123 is credit card information, withdrawal bank account information, or the like used when the payment terminal 100 performs payment processing according to the success of the biometric authentication.

The memory 520 is a volatile storage device such as a random access memory (RAM), and is a storage area for temporarily holding information during the operation of the control unit 540. The communication unit 530 is a communication interface with the network N.

The control unit 540 is a processor that controls each component of the store management apparatus 500, that is, a control apparatus. The control unit 540 reads the program 511 from the storage unit 510 into the memory 520 and executes the program 511. As a result, the control unit 540 implements the functions of a registration unit 541, an authentication control unit 542, a certification information issuing unit 543, and a payment processing unit 544.

The registration unit 541 receives a member registration request including a face image, personal information, and payment information from a certain user terminal 200, and performs processing of registration of face information and member information. Specifically, the registration unit 541 acquires a face image from the member registration request, and transmits a face information registration request including the acquired face image to the authentication apparatus 600. Then, the registration unit 541 receives a user ID issued by the authentication apparatus 600 at the time of registering the face information from the authentication apparatus 600. In addition, the registration unit 541 acquires personal information and payment information from the member registration request, and registers the received user ID 5121, the acquired personal information 5122, and the acquired payment information 5123 in association with each other in the member DB 512.

When receiving a pre-authentication request including a face image of a user from a user terminal 200, the authentication control unit 542 transmits a face authentication request (request for first biometric authentication) including the face image to the authentication apparatus 600. Then, the authentication control unit 542 receives a face authentication result from the authentication apparatus 600. Further, when receiving a face authentication request (request for second biometric authentication) including a face image of a user from the payment terminal 100, the authentication control unit 542 transmits the face authentication request including the face image to the authentication apparatus 600. Then, the authentication control unit 542 receives a face authentication result from the authentication apparatus 600.

When the face authentication result in the first biometric authentication indicates success, the certification information issuing unit 543 issues certification information. Specifically, the certification information issuing unit 543 specifies the user ID included in the face authentication result, and reads the personal information 5122 associated with the specified user ID 5121 from the member DB 512. Then, the certification information issuing unit 543 generates certification information indicating that the pre-authentication has succeeded. At this time, the certification information issuing unit 543 may include the specified user ID 5121, the read personal information 5122, time information corresponding to the success of the first biometric authentication, and the like in the certification information. Here, the time information corresponding to the success of the first biometric authentication is information on a date and time (hour, minute, and second as necessary) indicating, for example, a time at which the face image is captured, an authentication time, or a date on which the certification information expires. Further, the certification information issuing unit 543 may include a nickname in the personal information 5122. Further, the certification information issuing unit 543 may include position information of the user terminal 200 from which the pre-authentication request is transmitted in the certification information. Here, the position information of the user terminal 200 may be included in the pre-authentication request, or may be position information of a radio base station that has established wireless communication connection with the user terminal 200 or the like.

Then, the certification information issuing unit 543 transmits the generated certification information to the user terminal 200 from which the pre-authentication request is transmitted. As will be described below, when the first biometric authentication has succeeded between the user terminal 200 and the authentication apparatus 600, the certification information issuing unit 543 may receive a certification information issuing request including a user ID from the user terminal 200. In this case as well, the certification information issuing unit 543 issues certification information as described above.

Note that the certification information issuing unit 543 may issue code information including information indicating that the pre-authentication has succeeded, the user ID, the time information, and the position information. In this case, the certification information issuing unit 543 transmits the code information included in the certification information to the user terminal 200.

When receiving a payment request from the payment terminal 100, the payment processing unit 544 performs payment processing. Specifically, the payment processing unit 544 acquires a user ID and a payment amount from the payment request, and reads payment information 5123 associated with the user ID 5121 acquired from the member DB 512. Then, the payment processing unit 544 performs payment processing for the payment amount using the payment information 5123. Then, the payment processing unit 544 transmits a payment result to the payment terminal 100.

Returning to FIG. 5, the description will be continued.

The authentication apparatus 600 is an information processing apparatus that manages facial feature information of the user and performs a face authentication. In response to a face authentication request received from the outside, the authentication apparatus 600 collates a face image or facial feature information included in the request with the facial feature information of each user, and transmits a collation result (authentication result) as a response to the request source.

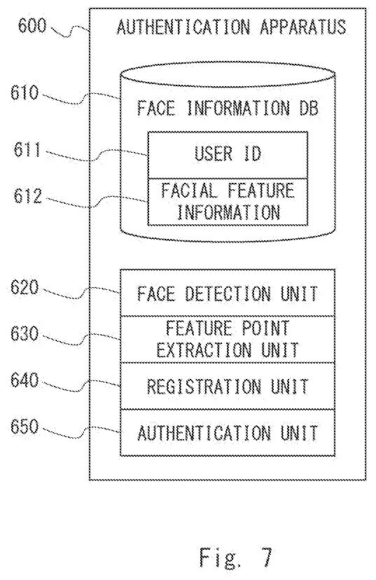

FIG. 7 is a block diagram illustrating a configuration of the authentication apparatus 600 according to the third example embodiment. The authentication apparatus 600 includes a face information DB 610, a face detection unit 620, a feature point extraction unit 630, a registration unit 640, and an authentication unit 650. The face information DB 610 stores a user ID 611 and facial feature information 612 of the user ID in association with each other. The facial feature information 612 is a set of feature points extracted from a face image. Note that the authentication apparatus 600 may delete facial feature information 612 in the face feature DB 610 in response to a request from a user or the like corresponding to the facial feature information 612. Alternatively, the authentication apparatus 600 may delete facial feature information 612 after a lapse of a certain period from the registration of the facial feature information 612.

The face detection unit 620 detects a face area included in the image registered for registering face information, and outputs the face area to the feature point extraction unit 630. The feature point extraction unit 630 extracts feature points from the face area detected by the face detection unit 620, and outputs facial feature information to the registration unit 640. In addition, the feature point extraction unit 630 extracts feature points included in a face image received from the store management apparatus 500 or the like, and outputs facial feature information to the authentication unit 650.

The registration unit 640 newly issues a user ID 611 when registering the facial feature information. The registration unit 640 registers the issued user ID 611 and the facial feature information 612 extracted from the registered image in association with each other in the face information DB 610. The authentication unit 650 performs a face authentication using the facial feature information 612. Specifically, the authentication unit 650 collates the facial feature information extracted from the face image with the facial feature information 612 in the face information DB 610. When the collation has succeeded, the authentication unit 650 specifies a user ID 611 associated with the collated facial feature information 612. The authentication unit 650 transmits as a response whether the pieces of facial feature information match each other as a face authentication result to the request source. Whether the pieces of facial feature information match each other corresponds to whether the authentication has succeeded or failed. The match between the pieces of facial feature information means that the matching degree is greater than or equal to a threshold value. In addition, it is assumed that the face authentication result includes the specified user ID when the face authentication has succeeded.

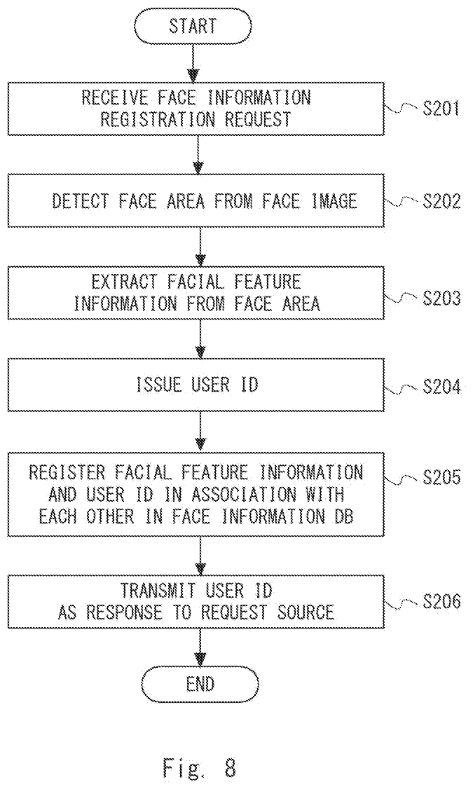

FIG. 8 is a flowchart illustrating a flow of face information registration processing performed by the authentication apparatus 600 according to the third example embodiment. First, the authentication apparatus 600 receives a face information registration request (S201). For example, the authentication apparatus 600 receives the face information registration request from the store management apparatus 500 via the network N. Next, the face detection unit 620 detects a face area from a face image included in the face information registration request (S202). Then, the feature point extraction unit 630 extracts feature points (facial feature information) from the face area detected in step S202 (S203). Then, the registration unit 640 issues a user ID 611 (S204). Then, the registration unit 640 registers the extracted facial feature information 612 and the issued user ID 611 in association with each other in the face information DB 610 (S205). Thereafter, the registration unit 640 transmits, as a response, the issued user ID 611 to a request source (e.g., the store management apparatus 500) (S206). Note that the authentication apparatus 600 may perform face information registration processing in response to a face information registration request received from any information registration terminal. For example, the information registration terminal is an information processing apparatus such as a personal computer, a smartphone, or a tablet terminal. In addition, the information registration terminal may be the user terminal 200.

Returning to FIG. 5, the description will be continued.

The user terminal 200-1 is an information terminal that can be carried by the user U1 and is capable of wireless communication. Here, it is assumed that the user U1 and the user terminal 200-1 exist in the second range 320 that is the vicinity of the entrance of the store 300. Here, it is assumed that the second range 320 is outside the first range 310, and is a range away from the first range 310 by a predetermined distance. Therefore, the second range 320 is not limited to the vicinity of the entrance of the store 300, and may be the outside of the store 300. The user U1 images the face using his/her user terminal 200-1 at a place different from the place in front of the payment terminal 100 (in the second range 320). The user terminal 200-1 transmits a face image to the authentication server 400 such that a face authentication is performed, receives certification information 222-1 from the authentication server 400 when the face authentication has succeeded, and store the certification information 222-1.

The user terminal 200-2 is an information terminal that can be carried by the user U2 and is capable of wireless communication. Here, it is assumed that the user U2 and the user terminal 200-2 exist in the first range 310 that is the vicinity of the cash register-installed location 311 in the store 300. It is assumed that the user terminal 200-2 receives certification information 222-2 in advance in the second range 320 and stores the certification information 222-2 therein. Then, the user terminal 200-2 outputs the certification information 222-2. Here, the certification information 222-1 and 222-2 are certification information indicating that the face authentication has succeeded in advance in the second range 320. Furthermore, the user terminal 200-2 may output the certification information 222-2 and transmit the certification information 222-2 to the payment terminal 100 by short-range wireless communication. Alternatively, the user terminal 200-2 may display the certification information 222-2 and cause the payment terminal 100 to read the certification information 222-2.

Note that the user terminals 200-1 and 200-2 have the same configuration. In the following description, when it is not necessary to particularly distinguish the user terminals 200-1 and 200-2 from each other, they will simply be collectively referred to as “user terminal 200”. The user terminal 200 is an example of the user terminal 2 described above. The user terminal 200 is, for example, an information terminal such as a mobile phone terminal, a smartphone, or a tablet terminal. The user terminal 200 communicates with the store management apparatus 500 and the authentication apparatus 600 included in the authentication server 400 via the network N. Furthermore, the users U1 and U2 may be the same person. That is, the user U1 carrying the user terminal 200-1 may move from the second range 320 to the first range 310 and be indicated as the user U2 carrying the user terminal 200-2.

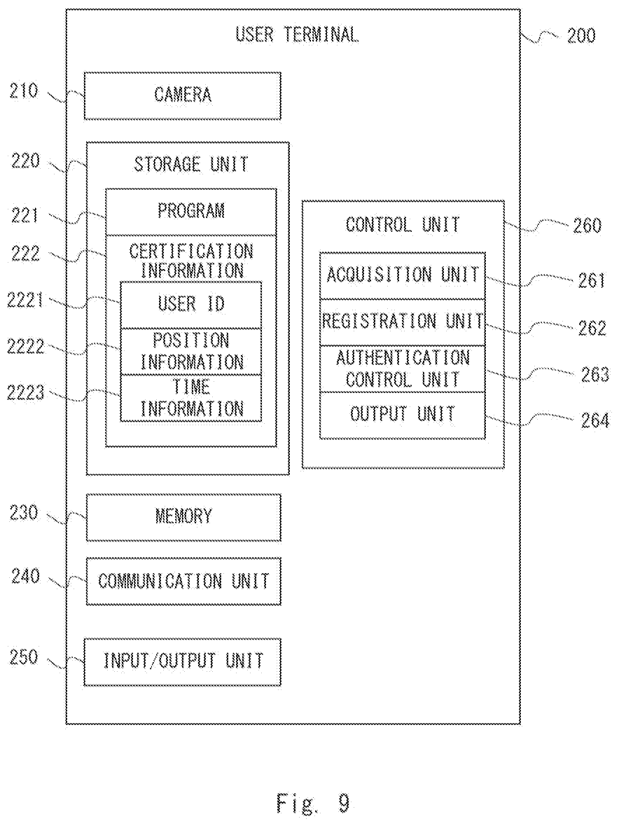

FIG. 9 is a block diagram illustrating a configuration of the user terminal 200 according to the third example embodiment. The user terminal 200 includes a camera 210, a storage unit 220, a memory 230, a communication unit 240, an input/output unit 250, and a control unit 260. The camera 210 is an imaging device that performs imaging under the control of the control unit 260. The storage unit 220 is a storage device such as a flash memory, and may be an example of the storage unit 23 described above. The storage unit 220 stores a program 221 and certification information 222. The program 221 is a computer program by which processing including processing of registration of face information and member information, pre-authentication processing, and processing of output of certification information according to the present example embodiment is implemented. The certification information 222 is an example of information indicating the success of the first biometric authentication and issued by the store management apparatus 500 when the pre-authentication has succeeded. The certification information 222 is information in which a user ID 2221, position information 2222, and time information 2223 are associated with each other. The user ID 2221 is identification information of a user who possesses the user terminal 200. The user ID 2221 is information corresponding to the user ID 5121 registered in the member DB 512. As described above, the position information 2222 is information indicating a position of the user terminal 200 when the pre-authentication has succeeded. As described above, the time information 2223 is time information corresponding to the success of the first biometric authentication. Note that the certification information 222 may include the above-described code information. In addition, the certification information 222 may include personal information corresponding to the user ID 2221, for example, a name of a member.

The memory 230 is a volatile storage device such as a RAM, and is a storage area for temporarily holding information during the operation of the control unit 260. The communication unit 240 is a communication interface with the network N. In particular, the communication unit 240 performs wireless communication. For example, the communication unit 240 establishes connection with radio base stations inside and outside the store 300 to perform communication. Furthermore, the communication unit 240 may establish connection for short-range wireless communication with the payment terminal 100 to perform communication. Here, various standards such as Bluetooth (registered trademark), Bluetooth Low Energy (BLE), and Ultra Wide Band (UWB) can be applied to the short-range wireless communication. Furthermore, the communication unit 240 may communicate with a global positioning system (GPS) satellite to acquire position information. The input/output unit 250 includes a display apparatus (display unit) such as a screen and an input apparatus. The input/output unit 250 is, for example, a touch panel. The control unit 260 is a processor that controls hardware included in the user terminal 200. The control unit 260 reads the program 221 from the storage unit 220 into the memory 230, and executes the program. As a result, the control unit 260 implements the functions of an acquisition unit 261, a registration unit 262, an authentication control unit 263, and an output unit 264.

The acquisition unit 261 is an example of the acquisition unit 21 described above. The acquisition unit 261 acquires a captured image including a face of a user imaged by the camera 210 according to an operation of the user. In addition, the acquisition unit 261 acquires member information including personal information and payment information input by the user. In addition, the acquisition unit 261 acquires a first captured image obtained by imaging the user U1 in the second range 320. That is, the acquisition unit 261 acquires the first captured image obtained by imaging the user U1 outside the first range 310 of the payment terminal 100. In addition, when a first biometric authentication has succeeded, the acquisition unit 261 acquires certification information 222 including a user ID 2221 of the user U1 from the authentication server 400 (store management apparatus 500). In addition, when a first biometric authentication has succeeded, the acquisition unit 261 acquires certification information 222 including position information 2222 of the user terminal 200 from the authentication server 400. In addition, when a first biometric authentication has succeeded, the acquisition unit 261 acquires certification information 222 including time information 2223 corresponding to the success of the first biometric authentication from the authentication server 400. Then, the acquisition unit 261 stores the acquired certification information 222 in the storage unit 220.

The registration unit 262 performs processing of registration of user's face information and member information. Specifically, the registration unit 262 transmits a member registration request including a face image, personal information, and payment information of the user to the store management apparatus 500. As a result, as described above, the facial feature information of the user is registered in the face information DB 610 of the authentication apparatus 600, and the member information is registered in the member DB 512 of the store management apparatus 500.

The authentication control unit 263 is an example of the authentication control unit 22 described above. The authentication control unit 263 extracts a person's face area detected from an image in which a user is imaged by the camera 210 as a face image, and transmits a pre-authentication request including the face image to the store management apparatus 500. Note that the authentication control unit 263 may include current time information and position information of the user terminal 200 in the pre-authentication request. Note that the authentication control unit 263 may directly transmit a face authentication request including the face image to the authentication apparatus 600 and receive a face authentication result from the authentication apparatus 600. Then, when the face authentication result indicates success, the authentication control unit 263 may extract a user ID included in the face authentication result and transmit a certification information issuing request including the user ID to the store management apparatus 500.

The output unit 264 is an example of the output unit 24 described above. The output unit 264 outputs certification information 222 acquired by the acquisition unit 261 by displaying the certification information 222. That is, the output unit 264 outputs the certification information 222 to the input/output unit 250, such that the certification information 222 is displayed on a screen. For example, the output unit 264 displays the certification information 222 to enable the user to confirm the content of the certification information 222. In addition, in a case where code information is included in the certification information 222, the output unit 264 displays the certification information 222 including the code information on the screen. By displaying the code information, the code information can be read by the payment terminal 100, and the certification information 222 can be acquired by the payment terminal 100.

Alternatively, the output unit 264 may output certification information 222 by transmitting the certification information 222 to the payment terminal 100 by the above-described short-range wireless communication. As a result, the certification information 222 can be acquired by the payment terminal 100.

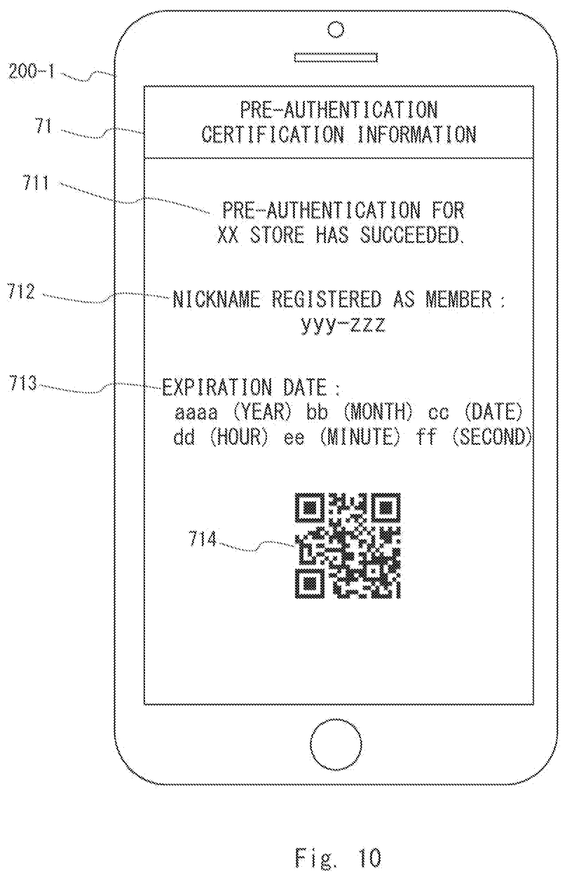

FIG. 10 is a diagram illustrating an example in which certification information is displayed according to the third example embodiment. Here, a case is illustrated in which the user terminal 200-1 performs a pre-authentication of the user U1 in the second range 320, and certification information acquired as a result of the pre-authentication is displayed when the pre-authentication has succeeded. A pre-authentication certification information display screen 71 is an example of the screen displayed on the input/output unit 250 of the user terminal 200-1. The pre-authentication certification information display screen 71 includes a message display field 711, a nickname display field 712, an expiration date display field 713, and code information 714.

In the message display field 711, a message “pre-authentication for XX store has succeeded” is displayed as an example. The message displayed in the message display field 711 is not limited thereto. Here, various methods can be used to specify “XX store”, that is, a store name. For example, in the second range 320, the user terminal 200 may specify the store name based on position information of the terminal at the time of activating a pre-authentication application provided by the store 300. Alternatively, the store management apparatus 500 may specify the store name based on position information of the user terminal 200 included in a pre-authentication request from the user terminal 200. In this case, the store management apparatus 500 transmitted, as a response, certification information issued to include the store name, the store information, and the like to the user terminal 200. Alternatively, outside the store 300, the user terminal 200 may perform a pre-authentication of the user U1 as a member of a company that manages the store 300 by using an integration service application provided by the company. In that case, the pre-authentication has been completed at the time when the user U1 and the user terminal 200 enter the store 300.

The nickname display field 712 is, for example, a field for displaying a nickname (registered as a member) in the personal information included in the certification information 222. As a result, the user U1 can visually recognize whether the face authentication is correctly performed for the user U1. Therefore, if the nickname displayed in the nickname display field 712 is not for the user U1, the user U1 can photograph his/her face again with the camera 210 and perform a pre-authentication. At this time, the user U1 can also perform imaging by moving to a place having different brightness or the like. In addition, by displaying the nickname, another person's nickname is displayed in case of false authentication. Therefore, the user U1 can identify that the displayed nickname is not his/her nickname, while the user U1 is not allowed to see personal information such as a member ID or a name of another person who has been erroneously identified. Therefore, leakage of personal information can be suppressed. As another example in which a pre-authentication certification information display screen 71 is displayed, a member ID display field or a member name display field may be provided instead of the nickname display field 712 or together with the nickname display field 712. The member ID display field is a field for displaying a user ID 2221 or a member ID corresponding thereto. In addition, the member name display field is a field for displaying a name included in personal information corresponding to the user ID 2221.

The expiration date display field 713 is a field for displaying year, month, date, hour, minute, and second indicating the date when the certification information expires as an example of the time information 2223 included in the certification information 222. The expiration date may be, for example, 30 minutes after a pre-authentication succeeds. Instead of the expiration date display field 713, a pre-authentication success time may be displayed.

Furthermore, in a case where the time information 2223 is a pre-authentication success time, the output unit 264 may display a time after a lapse of a predetermined time (for example, 30 minutes) from the time information as the expiration date.

As described above, the code information 714 is information including the fact that the pre-authentication has succeeded, the user ID, the time information, and the position information. Here, an example of a quick response (QR) code (registered trademark), which is a two-dimensional code, is displayed as the code information 714, but the code information 714 may be another type of code information such as a two-dimensional code of another standard, a one-dimensional code, or a number.

Returning to FIG. 5, the description will be continued.

The payment terminal 100 is an example of the processing execution apparatus 1 described above. The payment terminal 100 is an information processing apparatus installed at the cash register-installed location 311 to perform payment processing according to the success of the face authentication. The payment terminal 100 may be either a manned cash register terminal or an unmanned cash register terminal. In addition, the payment terminal 100 controls a face authentication using the authentication server 400. In particular, the payment terminal 100 directly performs a face authentication (second biometric authentication) to the user who has succeeded in the pre-authentication (first biometric authentication) on condition that the above-described certification information is presented, and performs payment processing when the user who has succeeded in the first biometric authentication matches the user who has succeeded in the second biometric authentication.

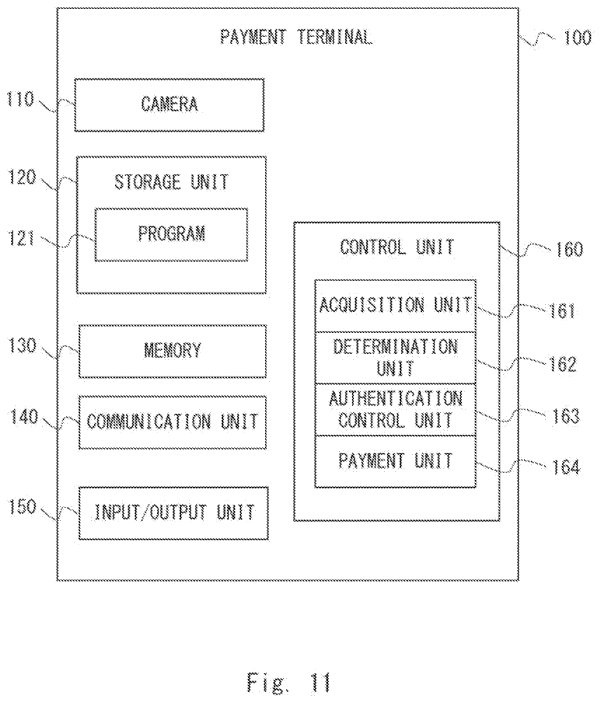

FIG. 11 is a block diagram illustrating a configuration of the payment terminal 100 according to the third example embodiment. The payment terminal 100 includes a camera 110, a storage unit 120, a memory 130, a communication unit 140, an input/output unit 150, and a control unit 160. Note that the payment terminal 100 may be connected to a code reader (not illustrated) that reads code information. The camera 110 is an imaging device that performs imaging under the control of the control unit 160. For example, the camera 110 images a face of the user U2 existing in the first range 310. The storage unit 120 is an example of a storage device such as a hard disk or a flash memory. The storage unit 120 stores a program 121. The program 121 is a computer program by which processing including payment processing according to the third example embodiment is implemented.

The memory 130 is a volatile storage device such as a RAM, and is a storage area for temporarily holding information during the operation of the control unit 160. The communication unit 140 is a communication interface with the network N. The communication unit 140 may establish connection for short-range wireless communication with the user terminal 200 to perform communication. The input/output unit 150 includes a display apparatus (display unit) such as a screen and an input apparatus. The input/output unit 150 is, for example, a touch panel. The control unit 160 is a processor that controls hardware included in the payment terminal 100. The control unit 160 reads the program 121 from the storage unit 120 into the memory 130, and executes the program. As a result, the control unit 160 implements the functions of an acquisition unit 161, a determination unit 162, an authentication control unit 163, and a payment unit 164.

The acquisition unit 161 is an example of the acquisition unit 11 described above. The acquisition unit 161 acquires certification information from the user terminal 200-2 existing in the first range 310. For example, the acquisition unit 161 acquires the certification information from the user terminal 200-2 in the first range 310 by short-range wireless communication. Alternatively, the acquisition unit 161 may acquire certification information by reading the certification information (code information) displayed on the user terminal 200-2.

The determination unit 162 determines whether the certification information acquired by acquisition unit 161 indicates that the pre-authentication (first biometric authentication) has succeeded. The determination unit 162 may also determine whether the time information included in the certification information indicates is within the expiration date. Further, the determination unit 162 may determine whether the position information included in the certification information is included in the second range 320 away from the first range 310 by a predetermined distance. Then, when it is determined that the pre-authentication has succeeded, the determination unit 162 specifies a user ID included in the certification information.

In addition, the determination unit 162 determines whether the result of the second biometric authentication is successful. Specifically, the determination unit 162 determines whether a face authentication has succeeded based on a face authentication result received by the authentication control unit 163 to be described below. When the face authentication has succeeded, the determination unit 162 determines whether the user ID included in the certification information matches the user ID included in the face authentication result.

The authentication control unit 163 is an example of the authentication control unit 12 described above. When the determination unit 162 determines that the pre-authentication has succeeded, the authentication control unit 163 initiates a control of a face authentication. Specifically, the authentication control unit 163 controls the camera 110 to photograph an area including a face of the user U2 who is a payment target person existing in the first range 310. Then, the authentication control unit 163 extracts the person's face area detected from the image captured by the camera 110 as a face image, and transmits a face authentication request including the face image to the authentication server 400 (the store management apparatus 500 or the authentication apparatus 600). The authentication control unit 163 may include the face image itself or a face feature amount extracted from the face image, as biometric information, in the face authentication request. Then, the authentication control unit 163 receives a face authentication result from the authentication server 400. Note that the authentication control unit 163 may initial a control of a face authentication (second biometric authentication) when the time information included in the certification information is within the expiration date. In addition, the authentication control unit 163 may initiate a control of a face authentication (second biometric authentication) when the position information included in the certification information is included in the second range 320 away from the first range 310 by a predetermined distance.

The payment unit 164 is an example of the execution unit 13 described above. The payment unit 164 executes payment processing when the determination unit 162 determines that the user ID indicated by the certification information matches the user ID of the user who has succeeded in the face authentication (second biometric authentication). Specifically, as will be described below, the payment unit 164 performs payment processing for the user who has succeeded in the face authentication, using the store management apparatus 500.

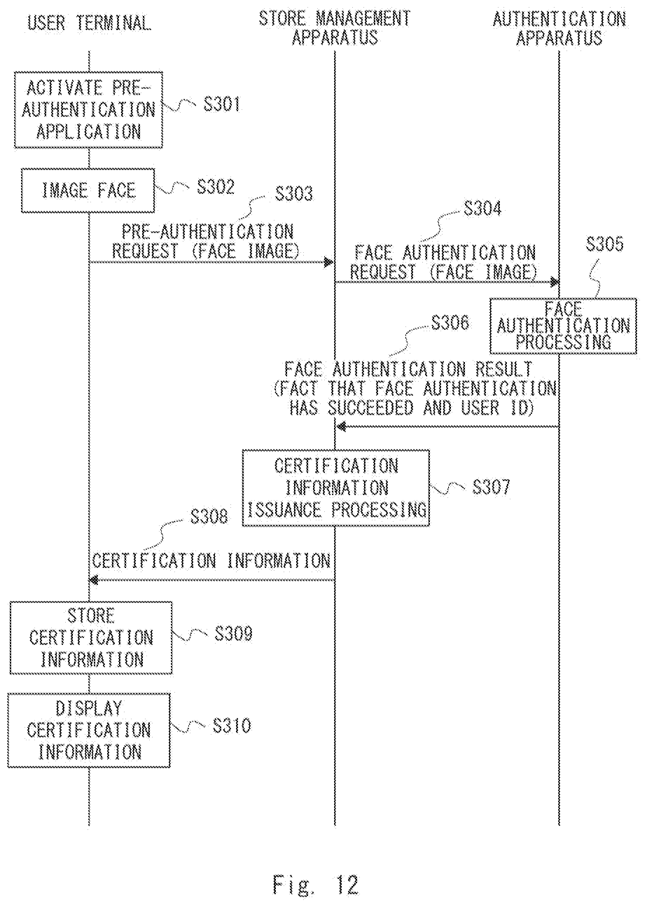

FIG. 12 is a sequence diagram illustrating a flow of pre-authentication processing according to the third example embodiment. Here, it is assumed that the user U1 carrying the user terminal 200-1 visits the store 300 as a visitor. Then, it is assumed that the user U1 performs a pre-authentication within the second range 320 that is the vicinity of the entrance of the store 300 to acquire certification information.

First, the user terminal 200-1 activates a pre-authentication application (S301). For example, it is assumed that a notice such as “in order to use a face payment, a pre-authentication using a pre-authentication application is necessary at the store entrance” is posted at the entrance of the store 300. In this case, the user U1 performs an operation of activating the pre-authentication application already installed in the user terminal 200-1. Alternatively, in a case where code information for activating a pre-authentication application is displayed at the entrance of the store 300, the user U1 images the code information with the camera 210 of the user terminal 200-1. Accordingly, the user terminal 200-1 analyzes the imaged code information, and initiates the pre-authentication application. Alternatively, in a case where a short-range wireless communication terminal is installed within the second range 320 of the store 300, the short-range wireless communication terminal may transmit a store entry notification (pre-authentication application activation notification) by broadcast communication or the like. In this case, the user terminal 200-1 may display the received store entry notification on the screen or notify the user U1, and may automatically or manually activate the pre-authentication application.

Next, the user terminal 200-1 images a face of the user U1 with the camera 210 using the function of the pre-authentication application according to an operation of the user U1 (S302). Then, the user terminal 200-1 transmits a pre-authentication request including the captured face image to the store management apparatus 500 via the network N (S303).

The store management apparatus 500 receives the pre-authentication request from the user terminal 200-1 via the network N, acquires the face image from the pre-authentication request, and transmits a face authentication request including the acquired face image to the authentication apparatus 600 via the network N (S304). Accordingly, the authentication apparatus 600 receives the face authentication request from the store management apparatus 500 via the network N, and performs face authentication processing (S305).

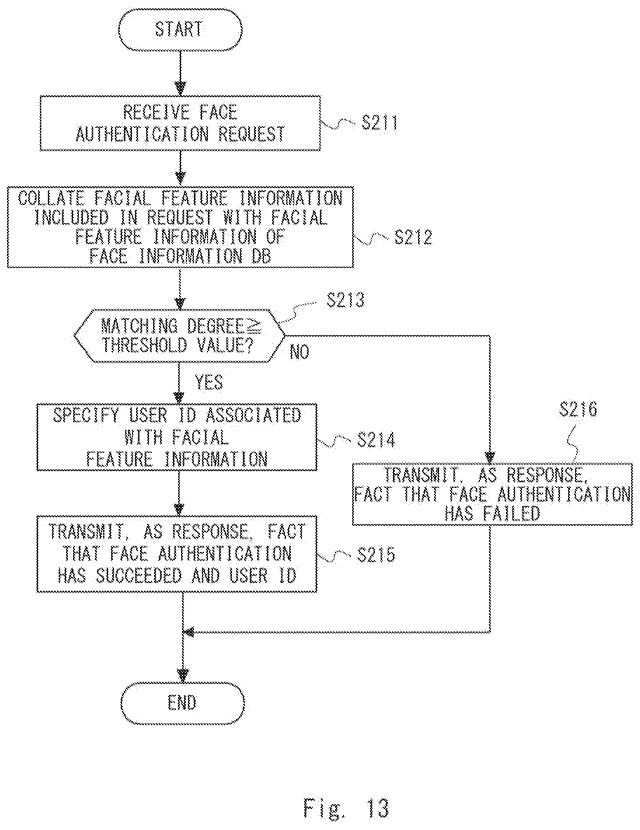

FIG. 13 is a flowchart illustrating a flow of face authentication processing performed by the authentication apparatus according to the third example embodiment. First, the authentication apparatus 600 receives a face authentication request from the store management apparatus 500 via the network N (S211). Note that the authentication apparatus 600 may receive a face authentication request from the user terminal 200, the payment terminal 100, or the like. Next, the authentication apparatus 600 extracts facial feature information from the face image included in the face authentication request, similarly to steps S202 and S203 described above. Then, the authentication unit 650 of the authentication apparatus 600 collates the facial feature information extracted from the face image included in the face authentication request with the facial feature information 612 of the face information DB 610 (S212), and calculates a matching degree. Then, the authentication unit 650 determines whether the matching degree is greater than or equal to a threshold value (S213). When the pieces of facial feature information match, that is, when the matching degree between the pieces of facial feature information is greater than or equal to the threshold value, the authentication unit 650 specifies a user ID 611 associated with the facial feature information 612 (S214). Then, the authentication unit 650 transmits, as a response, a face authentication result including the fact that the face authentication has succeeded and the specified user ID 611 to the store management apparatus 500 via the network N (S215). When the matching degree is smaller than the threshold value in step S213, the authentication unit 650 transmits, as a response, a face authentication result including the fact that the face authentication has failed to the store management apparatus 500 via the network N (S216).

Returning to FIG. 12, the description will be continued.

Thereafter, the store management apparatus 500 receives the face authentication result from the authentication apparatus 600 via the network N (S306). Then, the store management apparatus 500 determines whether the face authentication has succeeded based on the face authentication result. When the face authentication result indicates that the face authentication has failed, the store management apparatus 500 transmits, as a response, the fact that the authentication has failed to the user terminal 200-1 via the network N.

Here, it is assumed that the face authentication result includes the fact that the face authentication has succeeded and the user ID of the user U1. Therefore, the store management apparatus 500 determines that the user U1 has succeeded in the face authentication. Then, the store management apparatus 500 performs certification information issuance processing (S307). Specifically, as described above, the certification information issuing unit 543 of the store management apparatus 500 specifies a user ID of the user U1 included in the face authentication result, and reads personal information 5122 associated with the user ID 5121 of the user U1 from the member DB 512. The personal information may include, for example, a member name for display. Alternatively, the personal information may include a member ID. The member ID may be a user ID. Further, as described above, the certification information issuing unit 543 specifies time information corresponding to the success of the face authentication. Further, as described above, the certification information issuing unit 543 specifies position information of the user terminal 200-1. Further, as described above, the certification information issuing unit 543 may generate code information for specifying information including the fact that the face authentication has succeeded, the member ID (member name), the time information, and the position information. Then, the certification information issuing unit 543 generates certification information including the fact that the face authentication has succeeded, the member ID, the member name, the time information, the position information, and the code information.

Thereafter, the store management apparatus 500 transmits the generated certification information to the user terminal 200-1 via the network N (S308). Accordingly, the user terminal 200-1 receives the certification information from the store management apparatus 500 via the network N, and stores the received certification information as certification information 222 in the storage unit 220 (S309). Further, the user terminal 200-1 displays the received certification information 222 on the screen (S310). For example, the certification information 222 is displayed as in FIG. 10 described above. Furthermore, as described above, the user U1 can checks the member name or the like in the certification information displayed on the user terminal 200-1, determines that the face authentication has been authenticated when the displayed member name or the like is different from his/her name, and perform a pre-authentication by imaging the face again, for example, after slightly moving the place.

Note that, in step S303 of FIG. 12, the user terminal may directly transmit a face authentication request to the authentication apparatus without passing through the store management apparatus. Then, when the face authentication result received from the authentication apparatus indicates success, the user terminal transmits a certification information issuance request including the user ID included in the face authentication result to the store management apparatus. The store management apparatus executes step S307 and the subsequent steps in response to the certification information issuance request.

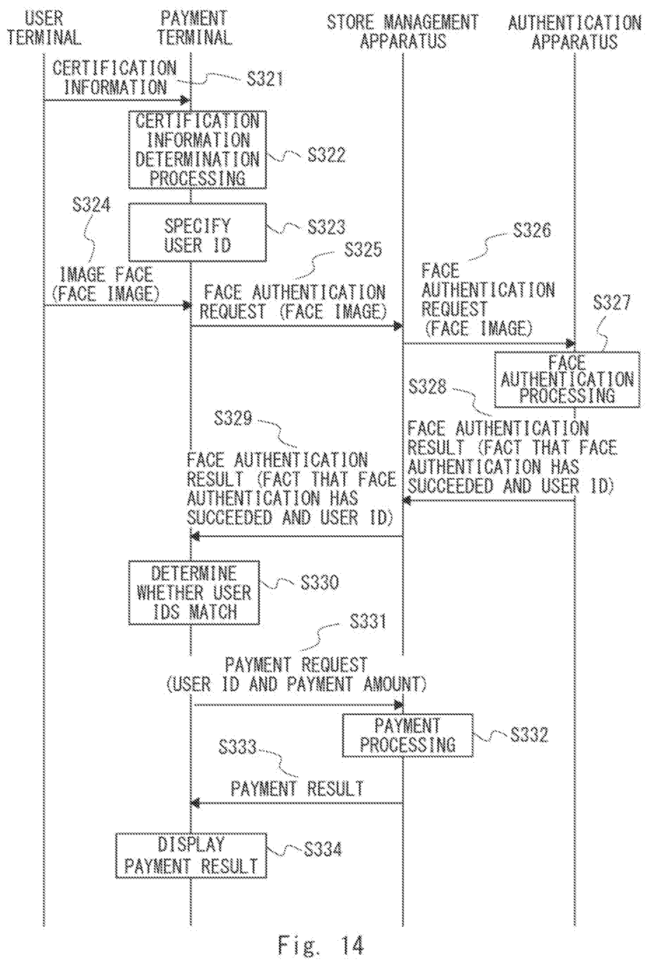

FIG. 14 is a sequence diagram illustrating a flow of payment processing according to the third example embodiment. Here, it is assumed that the above-described pre-authenticated user U1 has shopped in the store 300 and moved to the first range 310 for payment. In the following description, the user U1 and the user terminal 200-1 after movement will be described as a user U2 and a user terminal 200-2. That is, it is assumed that the user terminal 200-2 has stored the certification information 222-2. Furthermore, it is assumed that the user U2 and the user terminal 200-2 exist within the first range 310 of the payment terminal 100, that is, in front of or in the vicinity of the payment terminal 100.

First, the user terminal 200-2 outputs certification information 222-2 to the payment terminal 100 (S321). For example, as described above, the user terminal 200-2 may output the certification information 222-2 by short-range wireless communication such that the certification information 222-2 receives the payment terminal 100. Alternatively, as described above, the user terminal 200-2 may display code information of the certification information 222-2, and the payment terminal 100 may acquire the certification information by reading the code information using the camera 110 or a code reader and analyzing the code information.

Next, the payment terminal 100 performs determination processing on the acquired certification information (S322). Specifically, the payment terminal 100 determines whether the certification information indicates that the pre-authentication has succeeded. Here, since the certification information indicates that the pre-authentication has succeeded, the payment terminal 100 determines that the pre-authentication has succeeded. Further, the payment terminal 100 may determine whether time information included in the certification information is within the expiration date, and whether position information included in the certification information is included in the second range 320. Then, in a case where the time information is included in the certification information, the payment terminal 100 determines that the certification information is valid when the time information is within the expiration date. For example, the payment terminal 100 can perform payment processing based on face authentication, with one condition that the user U2 has performed the pre-authentication within 30 minutes. In addition, in a case where position information is included in the certification information, the payment terminal 100 determines that the certification information is valid when the position information is included in the second range 320. For example, the payment terminal 100 can perform payment processing based on face authentication, with one condition that the user U2 has performed the pre-authentication at a position within 100 m from the store 300.

When it is determined in step S322 that the pre-authentication has succeeded and the certification information is valid, the payment terminal 100 specifies a user ID included in the certification information (S323). Then, the payment terminal 100 initiates a control of a face authentication. Specifically, the payment terminal 100 acquires a face image by imaging a face of the user U2 with the camera 110 (S324). Then, the payment terminal 100 transmits a face authentication request including the captured face image to the store management apparatus 500 via the network N (S325).

The store management apparatus 500 receives the face authentication request from the payment terminal 100 via the network N, and transmits the face authentication request including the face image to the authentication apparatus 600 via the network N (S326). Accordingly, the authentication apparatus 600 receives the face authentication request from the store management apparatus 500 via the network N, and performs face authentication processing as in FIG. 13 described above (S327).

Thereafter, the store management apparatus 500 receives a face authentication result from the authentication apparatus 600 via the network N (S328). Then, the store management apparatus 500 transmits the received face authentication result to the payment terminal 100 via the network N (S329). Accordingly, the payment terminal 100 receives the face authentication result from the store management apparatus 500 via the network N.

Note that the payment terminal 100 may directly transmit a face authentication request to the authentication apparatus 600 without passing through the store management apparatus 500, and may directly receive a face authentication result from the authentication apparatus 600.

Then, the payment terminal 100 determines whether the face authentication has succeeded based on the face authentication result. When the face authentication result indicates that the face authentication has failed, the payment terminal 100 displays, on a screen, the fact that the authentication has failed, that is, the fact that it is not allowed to make a payment based on face authentication. Furthermore, the payment terminal 100 may notify the user terminal 200-2, by short-range wireless communication, that it is not allowed to make a payment based on face authentication.

Here, it is assumed that the face authentication result includes the fact that the face authentication has succeeded and the user ID of the user U2. Therefore, the payment terminal 100 determines that the user U2 has succeeded in the face authentication. Subsequently, the payment terminal 100 determines whether the user IDs between the pre-authentication and the face authentication immediately before the payment match (S330). That is, the payment terminal 100 determines whether the user ID specified in step S323 matches the user ID included in the face authentication result received in step S329.

When it is determined in step S330 that the user IDs match, the payment terminal 100 transmits a payment request including the user ID and a payment amount for a product or the like to be purchased by the user U2 to the store management apparatus 500 via the network N (S331). Accordingly, the store management apparatus 500 receives the payment request from the payment terminal 100 via the network N, and performs payment processing (S332). Specifically, the payment processing unit 544 of the store management apparatus 500 acquires the user ID and the payment amount from the received payment request, and reads payment information 5123 associated with the user ID 5121 acquired from the member DB 512. Then, the payment processing unit 544 performs payment processing for the payment amount using the payment information 5123. Then, the payment processing unit 544 transmits a payment result to the payment terminal 100 via the network N (S333). Accordingly, the payment terminal 100 receives the payment result from the store management apparatus 500 via the network N, and displays the payment result on the screen (S334). Furthermore, the payment terminal 100 may notify the user terminal 200-2 of the payment result by short-range wireless communication.

On the other hand, when it is determined in step S330 that the user IDs do not match, the payment terminal 100 displays, on the screen, the fact it is not allowed to make a payment based on face authentication. Furthermore, the payment terminal 100 may notify the user terminal 200-2, by short-range wireless communication, that it is not allowed to make a payment based on face authentication. As a result, for example, it is possible to prevent payment processing from being performed even though a person other than the user U2 (U1) is erroneously authenticated in the pre-authentication. When at least one of the pre-authentication or the face authentication at the time of payment is false authentication, it is possible to prevent payment processing.

As described above, in the present example embodiment, a pre-authentication is performed using a camera function of a terminal possessed by a store visitor at a place different from the cash register-installed location 311 (for example, at the entrance of the store or around the store), and it is allowed to make a payment based on face authentication when the success of the pre-authentication can be proved at the time of payment. That is, by combining biometric authentication results obtained at different places, two-stage authentications can be implemented, authentication accuracy can be improved, and reliability of predetermined processing according to the biometric authentication can be improved.

In addition, in a case where two-stage authentications are performed at the time of payment, the time required for the entire payment processing becomes long. Therefore, in the present example embodiment, the authentication processing time at the time of payment can be shortened by distributing the authentication timings, while reliability can be improved (maintained) by the two-stage authentications.

As described above, various methods such as face authentication, iris authentication, and fingerprint authentication can be used in combination for biometric authentications used for two-stage authentications. In particular, by using a face authentication or an iris authentication for a biometric authentication in the payment terminal 100, the user can perform payment processing in a non-contact manner. For example, at least one of the first biometric authentication and the second biometric authentication may be a face authentication.

Note that, in a case where a highly accurate biometric authentication technology (iris authentication or the like) other than the face authentication is used, it is difficult to perform such a biometric authentication using a camera mounted on a user terminal such as a general smartphone. Therefore, it is necessary to install a highly-accurate and expensive camera in the vicinity of the entrance of the store 300 or in the payment terminal 100, which may increase costs. In contrast, in the present example embodiment, by performing a combination of a pre-authentication and a before-payment authentication using face authentications, which is relatively inexpensive, at two stages, authentication accuracy can be improved without using another high-accuracy biometric authentication technology, thereby suppressing costs.

In addition, since the two-stage authentications can be performed under different background or brightness conditions by performing face authentications at different places, it is possible to reduce the likelihood of false authentication

Note that, although it is illustrated in FIG. 14 described above that the payment terminal 100 activates the camera 110 after steps S321 to S323, that is, after the certification information is acquired and the certification information is confirmed, the control of the face authentication is not limited thereto. For example, before step S321, the payment terminal 100 may activate the camera 110 to capture the face of the user U2, and control a face authentication after step S323. At this time, the payment terminal 100 may initiate the control of the face authentication by initiating processing of extracting a feature amount from the face image.

Further, the user terminal 200 transmits the face image at the time of processing of registration of face information or pre-authentication, but a face feature amount may be extracted from the face image, and the face feature amount may be included instead of the face image in the member registration request or the pre-authentication request. In addition, the store management apparatus 500 transmits a face image included in the face information registration request and the face authentication request, but a face feature amount may be extracted from the face image, and the face feature amount may be included, instead of the face image, in the face information registration request or the face authentication request.

Furthermore, in step S325 of FIG. 14, the payment terminal 100 may transmit a face authentication request in which the user ID specified in step S323 is included. In this case, the store management apparatus 500 transmits the face authentication request including the user ID and the face image to the authentication apparatus 600. As a result, the authentication apparatus 600 can perform a one-to-one authentication between the facial feature information corresponding to the (designated) user ID included in the received face authentication request and the face image (facial feature information) included in the received face authentication request. That is, the authentication processing can be performed by narrowing down the collation target in the face information DB 610. Therefore, the load of the authentication processing can be reduced, and the processing speed can be improved.

### Other Example Embodiments

Note that the above-described certification information may be registered in a predetermined server, and the user terminal may output a uniform resource locator (URL) including the address of the server instead of the certification information. It is assumed that the server is connected to the user terminal, the payment terminal, the store management apparatus, and the authentication apparatus via the network N. In addition, the URL may designate a folder or a directory of a destination for registration in the server, a name of an application operating in the server to perform processing of registration and acquisition of certification information, or the like. In such a case, the payment terminal may acquire the URL from the user terminal within the first range and download the certification information from the URL.

For example, in the certification information issuance processing of the pre-authentication processing, the store management apparatus transmits the certification information and the URL for the server that is a destination where the certificate information is registered to the user terminal. Then, the user terminal uploads the certification information onto the received URL and registers the certification information in the registration destination server. Thereafter, the user terminal outputs the received URL to the payment terminal. For example, the user terminal outputs URL information by short-range wireless communication, and the payment terminal acquires the URL information.

Alternatively, the store management apparatus issues code information of in the URL for the server that is a destination where the certification information is registered, and transmits the certification information, the URL for the registration destination server, and the code information to the user terminal. Then, the user terminal uploads the certification information onto the received URL and registers the certification information in the registration destination 10 server. Thereafter, the user terminal displays the received code information, and the payment terminal reads the code information with the camera or the like and analyzes the code information to acquire the URL.

Alternatively, the store management apparatus uploads the issued 15 certification information onto the registration destination server to register the certification information in the registration destination server. Then, the store management apparatus issues code information of the URL for the registration destination server, and transmits the code information to the user terminal. Alternatively, the store management apparatus may transmit the URL to the user 20 terminal. Then, the user terminal outputs the received URL information by short-range wireless communication, and the payment terminal acquires the URL information. Alternatively, the user terminal displays the received code information, and the payment terminal reads the code information with the camera or the like and analyzes the code information to acquire the URL.

Then, after doing so, the payment terminal can download the certification information from the acquired URL. Then, the processing of the steps after S323 in FIG. 14 described above is performed.

30 Alternatively, in the payment processing, the user terminal may not output the above-described information including the URL received from the store management apparatus to the payment terminal. Furthermore, in the payment processing, the user terminal may not display the information code including the URL and may not cause the payment terminal to read the information code. For example, the user terminal uploads the certification information to the URL received from the store management apparatus and registers the certification information in the registration destination server. Alternatively, a display plate displaying an information code including the URL for the server that is a destination where the certification information is registered may be installed near the payment terminal. Note that the information code may include a payment terminal ID and a store ID together with the URL. Furthermore, the URL included in the information code may be different for each payment terminal. Then, in the payment processing, the user terminal images the information code displayed on the display plate and extracts the URL. Then, the user terminal uploads the certification information onto the extracted URL and registers the certification information in the registration destination server. Thereafter, the registration destination server may transmit a registration completion notification including the URL to the payment terminal or to the payment terminal via the store management apparatus. The payment terminal may download the certification information from the URL included in the registration completion notification received from the registration destination server. Then, the processing of the steps after S323 in FIG. 14 described above is performed.

Furthermore, the payment terminal may acquire the certification information by reading the code information 714 of FIG. 10 with the camera or the like or by short-range wireless communication, and then display the captured face image of the user on a screen on the staff side of the store. Alternatively, the payment terminal may acquire the face image of the user who has succeeded in the pre-authentication from the authentication apparatus 600, and display the face image on the screen. That is, the payment terminal may display, on the screen, any one of the face image captured at the time of payment, the face image authenticated in advance, and the face image registered in advance. Note that the screen displaying the face image may be a screen of the payment terminal, in particular, a screen on the staff side at a position invisible on the user side, or a display apparatus installed in a staff room. As a result, the store staff can easily confirm the identity of the person with naked eyes.

Further, the store management apparatus may register the face image of the user who has succeeded in the pre-authentication in the registration destination server. Alternatively, the user terminal may register the face image of the user in the registration destination server when the pre-authentication succeeds. Then, the payment terminal may download the face image from the above-described URL and display the face image on the screen. Alternatively, the user terminal may register the face image together with the certification information in the registration destination server. In this case, the payment terminal may download the face image together with the certification information from the above-described URL and display the face image together with the certification information on the screen. As a result, the store staff can easily confirm the identity of the person with naked eyes. The face image downloaded together with the certification information may be an image registered in advance or an image captured when the pre-authentication has succeeded.

Note that, in the third example embodiment described above, the store management apparatus 500 and the authentication apparatus 600 have been described as separate information processing apparatuses, but may be the same apparatus. For example, the store management apparatus 500 may further register facial feature information in association with the user ID 5121 of the member DB 512. In this case, the control unit 540 only needs to further include the functions of the face detection unit 620, the feature point extraction unit 630, the registration unit 640, and the authentication unit 650 shown in FIG. 7.

In the above-described example, the program includes a group of instructions (or software codes) for causing a computer to perform one or more of the functions described in the example embodiments when read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer readable medium or a communication medium. As an example and not by way of limitation, the transitory computer readable medium or the communication medium includes propagated signals in electrical, optical, acoustic, or any other form.

Note that the present disclosure is not limited to the above-described example embodiments, and can be appropriately changed without departing from the scope. In addition, the present disclosure may be implemented by appropriately combining the example embodiments.

Some or all of the above-described example embodiments may be described as the following supplementary notes, but are not limited to the following.

### (Supplementary Note A1)

A processing execution apparatus including:
an acquisition means for acquiring certification information indicating that a first biometric authentication has succeeded from a user terminal possessed by a user after the user moves into a first range of a location where the processing execution apparatus is installed, the first biometric authentication being performed based on a first captured image in which the user is imaged by the user terminal outside the first range;
an authentication control means for initiating a control of a second biometric authentication for the user when the certification information is acquired; and
an execution means for executing predetermined processing when the second biometric authentication has succeeded.

### (Supplementary Note A2)

The processing execution apparatus according to supplementary note A1, in which
the certification information includes identification information of the user who has succeeded in the first biometric authentication, and
the execution means executes the predetermined processing when the identification information of the user indicated by the certification information matches identification information of the user who has succeeded in the second biometric authentication.

### (Supplementary Note A3)

The processing execution apparatus according to supplementary note A1 or A2, in which
the certification information includes time information corresponding to the success of the first biometric authentication, and
the authentication control means initiates the control of the second biometric authentication when the time information included in the certification information is within an expiration date.

### (Supplementary Note A4)

The processing execution apparatus according to any one of supplementary notes A1 to A3, in which
the certification information includes position information of the user terminal when the first biometric authentication has succeeded, and
the authentication control means initiates the control of the second biometric authentication when the position information included in the certification information is included in a second range away from the first range by a predetermined distance.

### (Supplementary Note A5)

The processing execution apparatus according to any one of supplementary notes A1 to A4, in which when the certification information is acquired, the authentication control means performs the control of the second biometric authentication by transmitting biometric information based on a second captured image obtained by imaging the user existing in the first range to the authentication server that has performed the first biometric authentication.

### (Supplementary Note A6)

The processing execution apparatus according to any one of supplementary notes A1 to A5, in which the acquisition means acquires the certification information from the user terminal within the first range by short-range wireless communication.

### (Supplementary Note A7)

The processing execution apparatus according to any one of supplementary notes A1 to A5, in which the acquisition means acquires the certification information by reading the certification information displayed on the user terminal.

### (Supplementary Note A8)

The processing execution apparatus according to any one of supplementary notes A1 to A7, in which at least one of the first biometric authentication and the second biometric authentication is a face authentication.

### (Supplementary Note B1)

A user terminal including:
an acquisition means for acquiring a first captured image obtained by imaging a user outside a first range of a location where a processing execution apparatus is installed;
an authentication control means for controlling a first biometric authentication by transmitting biometric information based on the first captured image to an authentication server;
a storage means for storing certification information acquired from the authentication server when the first biometric authentication has succeeded, the certification information indicating the success; and
an output means for outputting the certification information to cause the processing execution apparatus to perform a control of a second biometric authentication for the user and perform predetermined processing after the user moves into the first range.

### (Supplementary Note B2)

The user terminal according to supplementary note B1, in which
the acquisition means acquires the certification information from the authentication server when the first biometric authentication has succeeded, the certification information including identification information of the user, and
the output means outputs the certification information by displaying the certification information.

### (Supplementary Note B3)

The user terminal according to supplementary note B1 or B2, in which the acquisition means acquires the certification information from the authentication server when the first biometric authentication has succeeded, the certification information including time information corresponding to the success of the first biometric authentication, and
the output means outputs the certification information by displaying the certification information.

### (Supplementary Note B4)

The user terminal according to any one of supplementary notes B1 to B3, in which the output means outputs the certification information by transmitting the certification information to the processing execution apparatus by short-range wireless communication.

### (Supplementary Note B5)

The user terminal according to any one of supplementary notes B1 to B3, in which the output means outputs the certification information by displaying the certification information to be read by the processing execution apparatus.

### (Supplementary Note C1)

An authentication system including:
a user terminal possessed by a user;
an authentication server configured to perform a biometric authentication;

and
a processing execution apparatus installed at a first location and configured to execute predetermined processing, in which
the user terminal acquires a first captured image obtained by imaging the user outside a first range of the first location, and performs a control of a first biometric authentication by transmitting biometric information based on the first captured image to the authentication server,
the authentication server transmits certification information to the user terminal when the first biometric authentication has succeeded, the certification information indicating the success,
the user terminal stores the certification information acquired from the authentication server, and outputs the certification information after the user moves into the first range, and
the processing execution apparatus initiates a control of a second biometric authentication for the user when the certification information is acquired from the user terminal, and executes the predetermined processing when the second biometric authentication has succeeded.

### (Supplementary Note C2)

The authentication system according to supplementary note C1, in which
the certification information includes identification information of the user who has succeeded in the first biometric authentication, and
the processing execution apparatus executes the predetermined processing when the identification information of the user indicated by the certification information matches identification information of the user who has succeeded in the second biometric authentication.

### (Supplementary Note D1)

A processing execution method including:
by a computer installed at a first location,
acquiring certification information indicating that a first biometric authentication has succeeded from a user terminal possessed by a user after the user moves into a first range of the first location, the first biometric authentication being performed based on a first captured image in which the user is imaged by the user terminal outside the first range;
initiating a control of a second biometric authentication for the user when the certification information is acquired; and
executing predetermined processing when the second biometric authentication has succeeded.

### (Supplementary Note E1)

A non-transitory computer readable medium storing a program for causing a computer installed at a first location to execute:
acquisition processing of acquiring certification information indicating that a first biometric authentication has succeeded from a user terminal possessed by a user after the user moves into a first range of the first location, the first biometric authentication being performed based on a first captured image in which the user is imaged by the user terminal outside the first range;
authentication control processing of initiating a control of a second biometric authentication for the user when the certification information is acquired; and
execution processing of executing predetermined processing when the second biometric authentication has succeeded.

### (Supplementary Note F1)

An authentication method including:
by a computer,
acquiring a first captured image obtained by imaging a user outside a first range of a location where a processing execution apparatus is installed;
controlling a first biometric authentication by transmitting biometric information based on the first captured image to an authentication server;
storing certification information acquired from the authentication server when the first biometric authentication has succeeded, the certification information indicating the success; and
outputting the certification information to cause the processing execution apparatus to perform a control of a second biometric authentication for the user and perform predetermined processing after the user moves into the first range.

### (Supplementary Note G1)

A non-transitory computer readable medium storing a program for causing a computer to execute:
acquisition processing of acquiring a first captured image obtained by imaging a user outside a first range of a location where a processing execution apparatus is installed;
authentication control processing of controlling a first biometric authentication by transmitting biometric information based on the first captured image to an authentication server;
storage processing of storing certification information acquired from the authentication server in a storage device when the first biometric authentication has succeeded, the certification information indicating the success; and
output processing of outputting the certification information to cause the processing execution apparatus to perform a control of a second biometric authentication for the user and perform predetermined processing after the user moves into the first range.

Although the present invention has been described with reference to the example embodiments (and examples), the present invention is not limited to the above-described example embodiments (and examples). Various changes that can be understood by those skilled in the art can be made to the configurations and details of the present invention within the scope of the present invention.

### REFERENCE SIGNS LIST

1 PROCESSING EXECUTION APPARATUS
11 ACQUISITION UNIT
12 AUTHENTICATION CONTROL UNIT
13 EXECUTION UNIT
2 USER TERMINAL
21 ACQUISITION UNIT
22 AUTHENTICATION CONTROL UNIT
23 STORAGE UNIT
231 CERTIFICATION INFORMATION
24 OUTPUT UNIT
1000 AUTHENTICATION SYSTEM
U1 USER
U2 USER
N NETWORK
100 PAYMENT TERMINAL
110 CAMERA
120 STORAGE UNIT
121 PROGRAM
130 MEMORY
140 COMMUNICATION UNIT
150 INPUT/OUTPUT UNIT
160 CONTROL UNIT
16 ACQUISITION UNIT
162 DETERMINATION UNIT
163 AUTHENTICATION CONTROL UNIT
164 PAYMENT UNIT
200 USER TERMINAL
200-1 USER TERMINAL
200-2 USER TERMINAL
210 CAMERA
220 STORAGE UNIT
221 PROGRAM
222 CERTIFICATION INFORMATION
222-1 CERTIFICATION INFORMATION
222-2 CERTIFICATION INFORMATION
2221 USER ID
2222 POSITION INFORMATION
2223 TIME INFORMATION
230 MEMORY
240 COMMUNICATION UNIT
250 INPUT/OUTPUT UNIT
260 CONTROL UNIT
261 ACQUISITION UNIT
262 REGISTRATION UNIT
263 AUTHENTICATION CONTROL UNIT
264 OUTPUT UNIT
300 STORE
310 FIRST RANGE
311 CASH REGISTER-INSTALLED LOCATION
320 SECOND RANGE
400 AUTHENTICATION SERVER
500 STORE MANAGEMENT APPARATUS
510 STORAGE UNIT
511 PROGRAM
512 MEMBER DB
5121 USER ID
5122 PERSONAL INFORMATION
5123 PAYMENT INFORMATION
520 MEMORY
530 COMMUNICATION UNIT
540 CONTROL UNIT
541 REGISTRATION UNIT
542 AUTHENTICATION CONTROL UNIT
543 CERTIFICATION INFORMATION ISSUING UNIT
544 PAYMENT PROCESSING UNIT
600 AUTHENTICATION APPARATUS
610 FACE INFORMATION DB
611 USER ID
612 FACIAL FEATURE INFORMATION
620 FACE DETECTION UNIT
630 FEATURE POINT EXTRACTION UNIT
640 REGISTRATION UNIT
650 AUTHENTICATION UNIT
71 PRE-AUTHENTICATION CERTIFICATION INFORMATION DISPLAY
SCREEN
711 MESSAGE DISPLAY FIELD
712 NICKNAME DISPLAY FIELD
713 EXPIRATION DATE DISPLAY FIELD
714 CODE INFORMATION

What is claimed is:

1. A processing execution apparatus comprising:
at least one storage device configured to store instructions; and
at least one processor configured to execute the instructions to:
acquire certification information indicating that a first biometric authentication has succeeded from a user terminal possessed by a user after the user moves into a first range of a location where the processing execution apparatus is installed, the first biometric authentication being performed based on a first captured image in which the user is imaged by the user terminal outside the first range;
initiate a control of a second biometric authentication for the user when the certification information is acquired; and
execute predetermined processing when the second biometric authentication has succeeded.

2. The processing execution apparatus according to claim 1, wherein
the certification information includes identification information of the user who has succeeded in the first biometric authentication, and
wherein the at least one processor is further configured to execute the instructions to:
execute the predetermined processing when the identification information of the user indicated by the certification information matches identification information of the user who has succeeded in the second biometric authentication.

3. The processing execution apparatus according to claim 1, wherein
the certification information includes time information corresponding to the success of the first biometric authentication, and
wherein the at least one processor is further configured to execute the instructions to:
initiate the control of the second biometric authentication when the time information included in the certification information is within an expiration date.

4. The processing execution apparatus according to claim 1, wherein
the certification information includes position information of the user terminal when the first biometric authentication has succeeded, and
wherein the at least one processor is further configured to execute the instructions to:
initiate the control of the second biometric authentication when the position information included in the certification information is included in a second range away from the first range by a predetermined distance.

5. The processing execution apparatus according to claim 1,
wherein the at least one processor is further configured to execute the instructions to:
when the certification information is acquired, perform the control of the second biometric authentication by transmitting biometric information based on a second captured image obtained by imaging the user existing in the first range to the authentication server that has performed the first biometric authentication.

6. The processing execution apparatus according to claim 1,
wherein the at least one processor is further configured to execute the instructions to:
acquire the certification information from the user terminal within the first range by short-range wireless communication.

7. The processing execution apparatus according to claim 1,
wherein the at least one processor is further configured to execute the instructions to:
acquire the certification information by reading the certification information displayed on the user terminal.

8. The processing execution apparatus according to claim 1, wherein at least one of the first biometric authentication and the second biometric authentication is a face authentication.

9. A user terminal comprising:
at least one storage device configured to store instructions; and
at least one processor configured to execute the instructions to:
acquire a first captured image obtained by imaging a user outside a first range of a location where a processing execution apparatus is installed;
control a first biometric authentication by transmitting biometric information based on the first captured image to an authentication server;
store, in the at least one storage device, certification information acquired from the authentication server when the first biometric authentication has succeeded, the certification information indicating the success; and
output the certification information to cause the processing execution apparatus to perform a control of a second biometric authentication for the user and perform predetermined processing after the user moves into the first range.

10. The user terminal according to claim 9,
wherein the at least one processor is further configured to execute the instructions to:
acquire the certification information from the authentication server when the first biometric authentication has succeeded, the certification information including identification information of the user, and
output the certification information by displaying the certification information.

11. The user terminal according to claim 9,
wherein the at least one processor is further configured to execute the instructions to:
acquire the certification information from the authentication server when the first biometric authentication has succeeded, the certification information including time information corresponding to the success of the first biometric authentication, and
output the certification information by displaying the certification information.

12. The user terminal according to claim 9,
wherein the at least one processor is further configured to execute the instructions to:
output the certification information by transmitting the certification information to the processing execution apparatus by short-range wireless communication.

13. The user terminal according to claim 9,
wherein the at least one processor is further configured to execute the instructions to:
output the certification information by displaying the certification information to be read by the processing execution apparatus.

14. An authentication system comprising:
a user terminal possessed by a user;
an authentication server configured to perform a biometric authentication; and
a processing execution apparatus installed at a first location and configured to execute predetermined processing, wherein
the user terminal includes:
at least one first storage device configured to store first instructions; and
at least one first processor configured to execute the first instructions to:
acquire a first captured image obtained by imaging the user outside a first range of the first location, and perform a control of a first biometric authentication by transmitting biometric information based on the first captured image to the authentication server,
wherein the authentication server includes:
at least one second storage device configured to store second instructions; and
at least one second processor configured to execute the second instructions to:
transmit certification information to the user terminal when the first biometric authentication has succeeded, the certification information indicating the success,
wherein the at least one first processor is further configured to execute the first instructions to:
store, in the at least one first storage device, the certification information acquired from the authentication server, and output the certification information after the user moves into the first range, and
wherein the processing execution apparatus includes:
at least one third storage device configured to store third instructions; and
at least one third processor configured to execute the third instructions to:
initiate a control of a second biometric authentication for the user when the certification information is acquired from the user terminal, and execute the predetermined processing when the second biometric authentication has succeeded.

15. The authentication system according to claim 14, wherein
the certification information includes identification information of the user who has succeeded in the first biometric authentication, and
wherein the at least one third processor is further configured to execute the third instructions to:
execute the predetermined processing when the identification information of the user indicated by the certification information matches identification information of the user who has succeeded in the second biometric authentication.

16. A processing execution method comprising:
by a computer installed at a first location,
acquiring certification information indicating that a first biometric authentication has succeeded from a user terminal possessed by a user after the user moves into a first range of the first location, the first biometric authentication being performed based on a first captured image in which the user is imaged by the user terminal outside the first range;
initiating a control of a second biometric authentication for the user when the certification information is acquired; and
executing predetermined processing when the second biometric authentication has succeeded.

17. A non-transitory computer readable medium storing a program for causing a computer installed at a first location to execute:
acquisition processing of acquiring certification information indicating that a first biometric authentication has succeeded from a user terminal possessed by a user after the user moves into a first range of the first location, the first biometric authentication being performed based on a first captured image in which the user is imaged by the user terminal outside the first range;
authentication control processing of initiating a control of a second biometric authentication for the user when the certification information is acquired; and
execution processing of executing predetermined processing when the second biometric authentication has succeeded.

18. An authentication method comprising:
by a computer,
acquiring a first captured image obtained by imaging a user outside a first range of a location where a processing execution apparatus is installed;
controlling a first biometric authentication by transmitting biometric information based on the first captured image to an authentication server;
storing certification information acquired from the authentication server when the first biometric authentication has succeeded, the certification information indicating the success; and
outputting the certification information to cause the processing execution apparatus to perform a control of a second biometric authentication for the user and perform predetermined processing after the user moves into the first range.

19. A non-transitory computer readable medium storing a program for causing a computer to execute:
acquisition processing of acquiring a first captured image obtained by imaging a user outside a first range of a location where a processing execution apparatus is installed;
authentication control processing of controlling a first biometric authentication by transmitting biometric information based on the first captured image to an authentication server;
storage processing of storing certification information acquired from the authentication server in a storage device when the first biometric authentication has succeeded, the certification information indicating the success; and
output processing of outputting the certification information to cause the processing execution apparatus to perform a control of a second biometric authentication for the user and perform predetermined processing after the user moves into the first range.
